(19) United States
(12) Patent Application Publication
(10) Pub. No.: US 2003/0121802 A1
(43) Pub. Date: Jul. 3, 2003

(54) Method for disposing of oils, fats, and greases

(76) Inventor: Malcolm MacQuoid, Park City, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/271,973

(22) Filed: Oct. 15, 2002

Related U.S. Application Data
(60) Provisional application No. 60/329,660, filed on Oct. 16, 2001.

(51) Int. Cl. F17C 11/00; B65D 81/26

(52) U.S. Cl. 206/204

(57) ABSTRACT

A method for disposing of cooking oil comprises selecting a container with a biodegradable absorbent, such as peat moss or coconut coir, and pouring the cooking oil into the absorbent, or the absorbent into the cooking oil. The oil containing absorbent may then be safely disposed in a landfill or by burning the container.

### 1. RELATED APPLICATIONS

The present application claims the benefit of U.S. Provisional Patent Application 60/329,660, filed Oct. 16, 2001.

### BACKGROUND OF THE INVENTION

2. Field of the Invention

The present invention relates to a method for disposing of oils, fats, and greases. In particular, the present invention relates to a method for disposing oils, fats, and greases used or released in cooking. More particularly, the present invention involves the disposal of oil, fat and grease so as to prevent sewer damage and to comply with governmental regulations. Furthermore, the present invention relates to a method for cleaning pans and other cleaning implements.

3. State of the Art

In the process of cooking, numerous oils, fats, and greases are developed as bi-products of cooking the food, are added to the food being cooked to prevent sticking to pans, grills, etc., and/or are added to flavor the food. For example, in the cooking of meat, the meat fats release grease as the meat is cooked. Often, this grease appears to be very thin and almost water like while the pan is still hot, thereby giving the impression that little grease is present. However, after the pan is cooled, the amount of grease and fat can be readily determined as the liquid quickly turns to a whitish paste-like material. Other oil, fats, and greases which commonly are used in cooking, or are a bi-product of cooking, include lard, cooking oil, shortening, butter and margarine, food scraps, and some dairy products.

With the development of garbage disposals, many people have mistakenly believed that it is safe to simply pour the oils and greases down the sink, or disposal. They assume that the garbage disposal, or the addition of a small amount of detergent will break up the fat sufficiently that it will flow through the system. Further, they believe that the oil and greases do not pose any environmental risk, as many of these compounds are naturally occurring.

The assumption of most consumers, however, is completely inaccurate. Garbage disposals are not capable of breaking up oils and greases sufficiently to prevent significant property and environmental damage. Likewise, the small amount of soap used does not adequately break up the fats and oils.

Unbeknownst to many home-owners and businesses, fats and oils readily stick to and coat drainage and sewage pipes. Over time, the oils and greases build up and can completely occlude a pipe and prevent further drainage. In many instances, the oils and greases only travel a few feet down the pipes from the drain before they begin to solidify and stick to the pipe walls.

The oils, fats and greases which coat the drains provide a huge industry in the United States, and around the world, for drain cleaners. However, many of these drain cleaners only temporarily solublize these fats and greases and simply move the problem further down stream.

When oils and greases begin to coat the inside of sewage pipes, they can restrict flow and eventually seal off the sewage pipe. This can cause major back-ups which result in raw sewage overflowing into homes and businesses. Additionally, raw sewage can overflow into parks, yards, and the streets, exposing people to disease causing organisms, including, e.coli bacteria. Additionally, the oils and greases can negatively effect water treatment plants and can otherwise increase operation and maintenance costs for local sewer departments, thereby resulting in higher sewage bills for customers.

The threats posed by oils and greases are only magnified in the restaurant industry. A restaurant can produce several pounds of grease per day in the process of preparing meals. Because of the significant threat of operational and environmental damage posed by oils and greases, the disposal of oils, fats and greases have been closely regulated in restaurants. Most restaurants are required to have grease traps or filters which remove grease and oil from the water being discharged into the sewer system. Unfortunately, many such devices are poorly maintained or are intentionally made inoperative to allow oils and greases to flow into the sewage system. This is largely done because of the inconvenience in complying with disposal regulations, which require the oils and greases to be recycled or otherwise processed.

Because of the threats to sewage systems posed by the oils, fats and greases, many local sewage districts have issued press releases and other informational brochures to their customers. The brochures typically suggest that customers pour their grease and fats into a small container such as a milk carton or a disposable food container. The brochures also suggests that these materials then be disposed of in the garbage to protect the sewage pipes.

Putting fats and oils in the garbage, however, is often not a legal manner of disposing of these materials. The containers can quickly release the oil into the environment thereby allowing the cooking oil, etc. to contaminate groundwater supplies and other environmentally sensitive areas.

For these reasons, most restaurants and other commercial food preparation establishments are required by law to send their used cooking oil to recycling companies or other hazardous waste processors to process the oils for reuse or for proper disposal.

Unfortunately, many restaurants view the regulations as being expensive or unnecessary and dispose of their cooking oils and greases by simply throwing containers of the oils and greases in their trash bins. These containers, however, often leak when they are dumped in a land fill and pose a threat to the environment.

One fundamental problem which has prevented more individuals and companies from properly disposing of used cooking oils, greases, and other cooking by-products, is the lack of an easy, inexpensive way to dispose of the cooking oil other than pouring it down the sewage drain or sending it in liquid form to a landfill. Pouring it into a garbage can is usually impractical, as the garbage can will quickly become coated with the fats and oils. Over time, the fats and oils will break down, leaving an unpleasant odor. Additionally, the coating of fat and grease makes the garbage can harder to clean.

While disposing of fats, oils and grease from grills is problematic, simply disposing of the fats, oils and greases which occur in a frying pan can be challenging. The most common way to remove the oils, etc., from the pan is either to rinse the pan, thereby releasing the fat into the sewer system, or by cleaning the pan with paper towels and disposing of the paper towels in a garbage can. Such a method however, requires a large number of paper towels and can take numerous attempts to remove most of the oils.

Thus, there is a need for an improved method for disposing of oils, fats and greases left over after cooking. Such a method can preferably used to remove oils, etc., from grills, etc., and to remove oils from pans and the like.

### SUMMARY OF THE INVENTION

Thus, it is an object of the present invention to provide an improved method for disposing of oils, fats and greases.

It is another object of the invention to provide such a method which is relatively inexpensive and easy to use.

The above and other objects of the present invention are achieved by providing a container which is filled with a highly absorbent, biodegradable material. The biodegradable material absorbs the oils, etc. as it is poured into the container and substantially holds the oils in a non-fluid form so that naturally occurring microbes can brake down the oil long before it can migrate into ground water supplies or cause other damage.

In accordance with another aspect of the invention, the container is made from a biodegradable material, such as cardboard, paper, etc.

In accordance with another aspect of the invention, the container is at least partially filled with coconut coir. The coconut coir can absorb up to nine times its weight in oil, thereby allowing a relatively small amount of coconut coir to hold a substantial amount of oil, fat, grease.

While coconut coir is biodegradable, it breaks down very slowly. Thus, the coconut coir will hold the oil, grease, etc., for an extremely long time, thereby allowing naturally occurring microbes to break down the oil without releasing the oil into the ground water or other environmentally sensitive areas. By turning the oil into substantially a solid, the oil/coir mixture can be safely disposed of in common landfills, thereby removing the need to reprocess or recycle the oil.

In accordance with another aspect of the invention, the coconut coir can be used by adding the coconut coir to the contents of a pan, etc., after cooking. The coconut coir will absorb the fats, grease and oils, and form a mixture which is a flowable mass. The mixture can then be scraped into the garbage can. Because the coconut coir absorbs the oils, etc.

### BRIEF DESCRIPTION OF THE DRAWINGS

The above and other objects, features and advantages of the invention will become apparent from a consideration of the following detailed description presented in connection with the accompanying drawings in which:

FIG. 1 shows a bag of absorbent and a container for use in accordance with the principles of the present invention;

FIG. 2 shows a container filled with absorbent in accordance with the principles of the present invention; and

FIG. 3 shows the absorbent placed in a pan containing used cooking oil or grease for the purpose of absorbing the oil or grease.

### DETAILED DESCRIPTION

Reference will now be made to the drawings in which the various elements of the present invention will be given numeral designations and in which the invention will be discussed so as to enable one skilled in the art to make and use the invention. It is to be understood that the following description is only exemplary of the principles of the present invention, and should not be viewed as narrowing the pending claims.

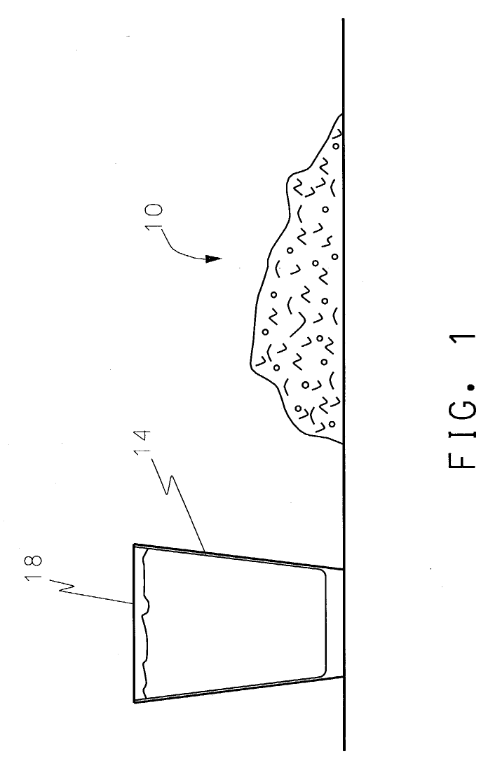

Turning to FIG. 1, there is shown a side view of an absorbent material, generally indicated at 10, and a container, generally indicated at 14. The absorbent material is preferably a biodegradable material, and is preferably formed from processed natural substances. Two acceptable absorbents include coconut coir and peat moss.

To dispose of cooking oil, fat, grease, etc., a quantity of the absorbent 10 is disposed in the container 14 through an opening 18 therein. Preferably the volume of absorbent 10 used is between about 1:1 and 2:1 to the amount of grease which needs to be disposed. Thus, if a pan has about half a cup of grease in it, the container, which can be a 1 cup yogurt container, is filled about half way with absorbent 10. The grease is then poured into the container 14, it is absorbed by the absorbent 10. The container 14 is then discarded.

Because of the strong absorbing action of the absorbent 10 relative to the grease, the absorbent holds the grease and will not release any significant amount of the grease into the remainder of a land fill for a sufficiently long period of time, that naturally occurring microbes will have the ability to break down the grease. Thus, the container 14 can be safely disposed of in municipal landfills.

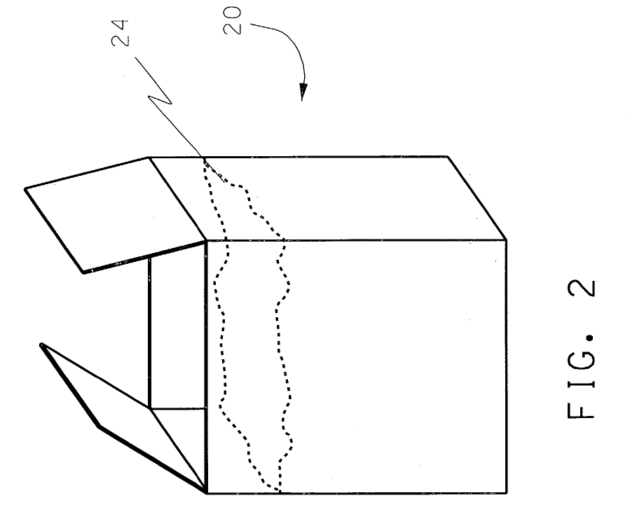

Turning now to FIG. 2, there is shown an alternate embodiment of the present invention in which a container, generally indicated at 20 is at least partially filled with an absorbent, indicated by dashed line 24.

The container 20 is preferably made from a biodegradable material, such as cardboard or paper, and the absorbent is preferably made from a biodegradable, flowable material, such as peat moss or coconut coir. In a most preferred aspect of the invention, the container 20 is made from cardboard and the absorbent is coconut coir. Most preferably, the coconut coir is processed to remove the long fibers used for making rope and fabric, so that small pieces of the husk (often called coir dust) remain.

Coconut coir is desirable as the absorbent because of its ability to absorb up to nine times its weight in oil or other liquids. Additionally, it is highly advantageous because it does not release any significant amounts of the oil even when it is exposed to water or other environmental conditions which would cause many other absorbents to release the oil.

One other advantage of using peat moss or coconut coir is that they will burn if placed in fire. Thus, a person camping, etc., can pour leftover grease into the container filled with absorbent. The container, particularly if made from cardboard, etc., can then be disposed of in the camp fire, where it will burn and consume both the container and the grease/coir. Those of ordinary skill in the art will appreciate that this is much safer than simply pouring hot grease from the pan into the fire wherein the grease can cause sudden bursts of flames and can splatter on those sitting around the fire. When captured by the absorbent, the grease will burn more evenly, along with the container and the coconut coir, etc., providing a usable fuel source.

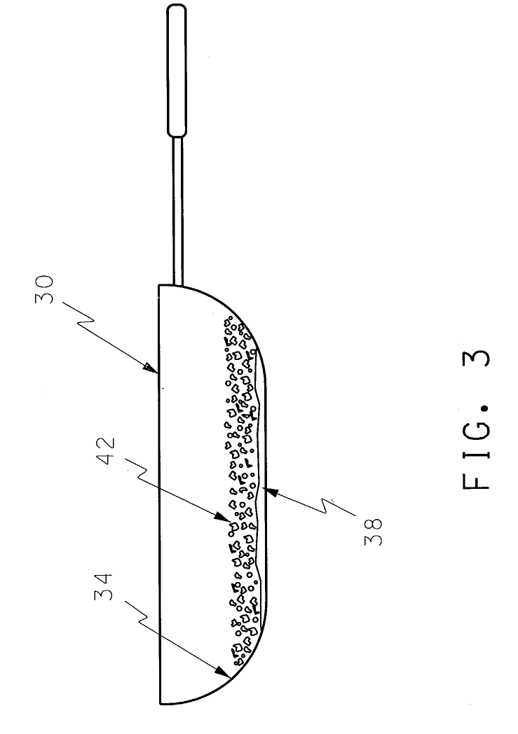

Turning to FIG. 3, there is shown a side view of a frying pan, generally indicated at 30, which contains on its interior surface 34, oil or grease, generally indicated at 38. The absorbent material is generally indicated at 42. The absorbent material 42 is generally disposed about the interior surface 34 of the pan in such a manner as to come into contact with and absorb the grease or oil 38. The absorbent material 42 is preferably a biodegradable material, and is preferably formed from processed natural substances. Two acceptable absorbent materials include coconut coir and peat moss, although coconut coir is strongly preferred due to its absorbency.

Preferably, the volume of absorbent material 42 used is typically between about 4:1 and 1:4 and preferably between about 3:1 and 1:3 to the amount of grease which needs to be removed. Thus, for example, if a pan has about half a cup of grease in it, about one-sixth to one and one half cups of absorbent material 42 should be placed in the pan. The absorbent may be moved around the pan to absorb all the oil. Additionally, the absorbent material 42 may be used to scour the pan. Once the absorbent material 42 has absorbed the grease or oil 18, the absorbent material 42 can be discarded in a conventional garbage can.

Because of the strong absorbing action of the absorbent material 42 relative to the grease or oil 38, the absorbent material 42 holds the grease or oil 38 and will not release any significant amount of the grease or oil 38 into the remainder of a land fill for a sufficiently long period of time, that naturally occurring microbes will have the ability to break down the grease or oil 38. Thus, the absorbent material 42 can be safely disposed by simply scraping it into a garbage can and subsequent disposal in a municipal landfill.

In a most preferred aspect of the invention, the absorbent material 42 is comprised of coconut coir. Most preferably, the coconut coir is processed to remove the long fibers used for making rope and fabric, so that small pieces of the husk remain.

Coconut coir is desirable as the absorbent material 42 because of its ability to absorb up to nine times its weight in oil. Additionally, it is highly advantageous because it does not release any significant amounts of the oil even when it is exposed to water or other environmental conditions which would cause many other absorbents to release the oil.

One other advantage of using peat moss or coconut coir is that they will burn if placed in fire. Thus, a person camping, etc., can scour pans and other cooking utensils with the absorbent material 42. The absorbent material can then be disposed of in the camp fire, where it will burn and consume both the absorbent and the grease or oil. Those of ordinary skill in the art will appreciate that this is much safer than simply pouring hot grease from the pan into the fire wherein the grease can cause sudden bursts of flames and can splatter on those sitting around the fire. When captured by the absorbent, the grease will burn more evenly, along with the coconut coir, etc., providing a usable fuel source.

Thus there is disclosed an improved apparatus and method for disposing of oils, fats and greases (collectively referred to in the claims as cooking oil). Those skilled in the art will appreciate numerous modifications which can be made without departing from the scope and spirit of the present invention. The appended claims are intended to cover such modifications.

What is claimed is:

1. A method for disposing of cooking oil, the method comprising:
selecting a container having a biodegradable absorbent disposed therein;
pouring cooking oil into the absorbent; and
disposing of the container.

2. The method for disposing of cooking oil, wherein the absorbent is selected from coconut coir and peat moss.

3. The method for disposing of cooking oil according to claim 1, wherein the method comprises having a ratio of absorbent to cooking oil of between about 4:1 to 1:4 by volume.

4. The method for disposing of cooking oil according to claim 2, wherein the absorbent is coconut coir having the long fibers removed.

5. The method for disposing of cooking oil according to claim 1, wherein the container is formed of a biodegradable material.

6. The method for disposing of cooking oil according to claim 1, wherein the container is formed from plastic.

7. The method for disposing of cooking oil according to claim 1, wherein the method further comprises disposing of the container, absorbent and oil in a landfill.

8. The method for disposing of cooking oil according to claim 1, wherein the container, absorbent and cooking oil are burned.

9. A method for disposing of cooking oil, the method comprising;
selecting a container;
pouring absorbent into the container; and
pouring cooking oil into the absorbent.

10. The method according to claim 9, wherein the method comprises pouring coconut coir into the container.

11. The method according to claim 10, wherein the method comprises pouring an amount of cooking oil into the coconut coir which is equal to or less than the amount of coconut coir based on volume.

12. The method according to claim 9, wherein the container is formed from a biodegradable material.

13. The method according to claim 9, wherein the method further comprises disposing of the container in a landfill.

14. The method according to claim 9, wherein the method further comprises disposing of the container by burning the container.

15. An apparatus for disposing of cooking oil, the apparatus comprising:
a container; and
an absorbent disposed in the container, the absorbent being either peat moss or coconut coir.

16. The apparatus according to claim 15, wherein the container is biodegradable.

17. The apparatus according to claim 16, wherein the container is cardboard.

18. A method for disposing of cooking oil, the method comprising:
placing a biodegradable absorbent material comprising coconut coir or peat moss into a cooking utensil containing cooking oil for the purpose of absorbing the oil; and
disposing of the absorbent.

19. The method for disposing of cooking oil according to claim 18, wherein the method comprises having a ratio of absorbent to cooking oil of between about 4:1 to 1:4 by volume.

20. The method for disposing of cooking oil according to claim 18, wherein the method comprises using absorbent is coconut coir having the long fibers removed.

21. The method for disposing of cooking oil according to claim 18, wherein the method further comprises disposing of the absorbent and oil in a garbage can.

22. The method for disposing of cooking oil according to claim 18, wherein the method further comprises disposing of the absorbent and oil in a landfill.

23. The method for disposing of cooking oil according to claim 1, wherein the absorbent and cooking oil are burned.
